(19) United States
(12) Patent Application Publication
(10) Pub. No.: US 2026/0184233 A1
(43) Pub. Date: Jul. 2, 2026

(54) DRIVING RANGE MONITORING SYSTEM

(71) Applicant: TOYOTA JIDOSHA KABUSHIKI KAISHA, Toyota-shi (JP)

(72) Inventors: Hiroto AMADA, Nagakute-shi (JP); Noritaka TAKUDA, Okazaki-shi (JP)

(73) Assignee: TOYOTA JIDOSHA KABUSHIKI KAISHA, Toyota-shi (JP)

(21) Appl. No.: 19/423,340

(22) Filed: Dec. 17, 2025

(30) Foreign Application Priority Data
Dec. 19, 2024 (JP) 2024-223863

(51) Int. Cl. B60L 58/27

(52) U.S. Cl. CPC B60L 58/27; B60L 2240/42; B60L 2240/545; B60L 2260/52

(57) ABSTRACT

A driving range monitoring system for accurately monitoring a driving range of a vehicle that is changed by heating a battery. The driving range monitoring system comprises: a first calculator that calculates a first driving range available with an available electric power for propelling the vehicle when a demand to heat the battery arises; a second calculator that calculates a second driving range available with the entire electric power remaining in the battery for driving a motor and heating the battery when the demand to heat the battery arises; and a transmitter that indicates the longer one of the first driving range and the second driving range on an indicator.

### CROSS-REFERENCE TO RELATED APPLICATIONS

The present disclosure claims the benefit of Japanese Patent Application No. 2024-223863 filed on Dec. 19, 2024 with the Japanese Patent Office, the disclosures of which are incorporated herein by reference in its entirety.

### BACKGROUND

### Field of the Disclosure

The embodiment of the present disclosure relates to the art of a driving range monitoring system configured to monitor a driving range of an electric vehicle propelled by an electric power supplied from an electric storage device, and more specifically, to a driving range monitoring system configured to monitor a driving range of the electric vehicle available with the electric power remaining in the electric storage device.

### Discussion of the Related Art

Electric vehicles such as a battery electric vehicle (BEV) and a plug-in hybrid vehicle (PHEV) are well known in the art. Those electric vehicles are provided with a large-capacity battery, and propelled by driving a motor by an electric power supplied from the battery. Therefore, when a state of charge level of the battery is low, it is necessary to go to a charging station to charge the battery by a charging facility installed in the charging station. To this end, as the conventional gasoline vehicles, the electric vehicles are provided with an indicator for indicating a state of charge level of the battery and an available driving range.

For example, a secondary battery such as a lithium-ion battery is adopted as the battery in the electric vehicles. The secondary battery is allowed to discharge the electricity as expected and a required time to charge the secondary battery is reduced in a condition where a temperature thereof is raised to a certain level. Therefore, in a battery apparatus described in JP-A-2003-223938, the secondary batteries are heated by a plurality of heaters fixed to a temperature detecting plate. According to the teachings of JP-A-2003-223938, heating of the secondary battery is started when an ignition switch is turned ON to propel an automobile, and stopped when a temperature of the battery is raised higher than a preset temperature.

The secondary battery is heated using an electric power accumulated in the secondary battery, and a large amount of the electric power is required to heat the secondary battery. Especially, a required amount of the electric power is increased significantly in the winter time in which an external temperature is extremely low. In the electric vehicles, the secondary battery serves as a power source to supply the electric power to a motor for propelling the electric vehicle. Therefore, if the secondary battery is heated during propulsion of the electric vehicle before charging, the electric power in the battery is consumed to heat the secondary battery thereby reducing an available driving range. Therefore, the available driving range should be indicated accurately in the indicator to allow a driver to determine an appropriate timing to charge the battery. However, techniques to indicate the available driving range accurately and appropriately while executing a preconditioning to heat the battery are not available in the art. Therefore, an innovative technique has to be developed to monitor and indicate the driving range accurately and properly while executing a preconditioning of the battery.

### SUMMARY

The embodiment of the present disclosure has been conceived noting the foregoing technical problems, and it is therefore an object of the present disclosure to provide a driving range monitoring system for accurately monitoring a driving range of a vehicle that is changed by heating an electric storage device.

According to the exemplary embodiment of the present disclosure, there is provided a driving range monitoring system that monitors a driving range of an electric vehicle. The electric vehicle to which the driving range monitoring system is applied comprises: an electric storage device that accumulates an electric power for propelling the electric vehicle; and a heater that heats the electric storage device using the electric power accumulated in the electric storage device. In order to achieve the above-explained objective, according to the exemplary embodiment of the present disclosure, the driving range monitoring system is provided with: an indicator that indicates a driving range available with a current state of charge level of the electric storage device; and a controller that calculates the driving range indicated on the indicator. According to the exemplary embodiment of the present disclosure, the controller comprises: a first calculator that is configured to calculate a first driving range available with an available electric power calculated by subtracting a required amount of the electric power to raise the temperature of the electric storage device to a target temperature level from an amount of the electric power remaining in the electric storage device, in a situation where a demand to heat the electric storage device arises during propulsion of the electric vehicle; a second calculator that is configured to calculate a second driving range available with the electric power remaining in the electric storage device given that a prime mover is driven by the electric power remaining in the electric storage device, and that the electric storage device is also heated by the electric power remaining in the electric storage device, in the situation where the demand to heat the electric storage device arises during propulsion of the electric vehicle; and a transmitter that is configured to indicate the longer one of the first driving range and the second driving range on the indicator.

In a non-limiting embodiment, the first calculator may be further configured to calculate the first driving range based on: a rate of power consumption to propel the electric vehicle obtained from data collected during propulsion of the electric vehicle; and the available electric power, and the second calculator may be further configured to calculate the second driving range based on: a total rate of the rate of power consumption to propel the electric vehicle obtained from data collected during propulsion of the electric vehicle, and a rate of power consumption to raise the temperature of the electric storage device to the target temperature level; and the electric power remaining in the electric storage device.

In a non-limiting embodiment, the controller may further comprise a third calculator that is configured to calculate a third driving range based on: the electric power remaining in the electric storage device; and the rate of power consumption to propel the electric vehicle obtained from data collected during propulsion of the electric vehicle, in a situation where a heating of the electric storage device is not demanded during propulsion of the electric vehicle, and the transmitter is further configured to indicate the third driving range on the indicator in the situation where the heating of the electric storage device is not demanded during propulsion of the electric vehicle.

In a non-limiting embodiment, the electric storage device may include a secondary battery.

Thus, according to the exemplary embodiment of the present disclosure, the longer one of the first driving range and the second driving range is indicated on the indicator as an available distance to travel while raising the temperature of the electric storage device to the target temperature level in the situation where the demand to heat the electric storage device arises. That is, in the situation where the heating of the electric storage device is demanded, the first driving range that is calculated based on the available electric power calculated by subtracting the required amount of the electric power to heat the electric storage device from the remaining electric power in the electric storage device will not be indicated on the indicator. According to the exemplary embodiment of the present disclosure, therefore, a difference between the accrual driving range available with the current state of charge level of the electric storage device and the driving range indicated on the indicator may be reduced. For this reason, the driving range of the electric vehicle may be monitored accurately.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of the vehicle to which the driving range monitoring system according to the exemplary embodiment of the present disclosure is applied;

FIGS. 2A and 2B are front views of an indicator, FIG. 2A showing one example of a selector switch indicated in the form of icon, and FIG. 2B showing one example of a current driving range;

FIG. 3 is a line chart showing changes in a temperature of the electric storage device in the manual heating mode and in the automatic heating mode;

FIG. 4 is a block diagram showing functions of the controller;

FIG. 5 is a flowchart showing one example of a routine executed by the controller; and

FIGS. 6A and 6B are line charts showing changes in the first driving range and the second driving range during propulsion of the vehicle, FIG. 6A showing an example of a case in which the state of charge level of the electric storage device is high, and FIG. 6B showing an example of a case in which the state of charge level of the electric storage device 3 is low.

### DETAILED DESCRIPTION OF THE PREFERRED EMBODIMENT(S)

An exemplary embodiment of the present disclosure will now be explained with reference to the accompanying drawings. Note that the embodiments shown below are merely examples of the present disclosure, and do not limit the present disclosure.

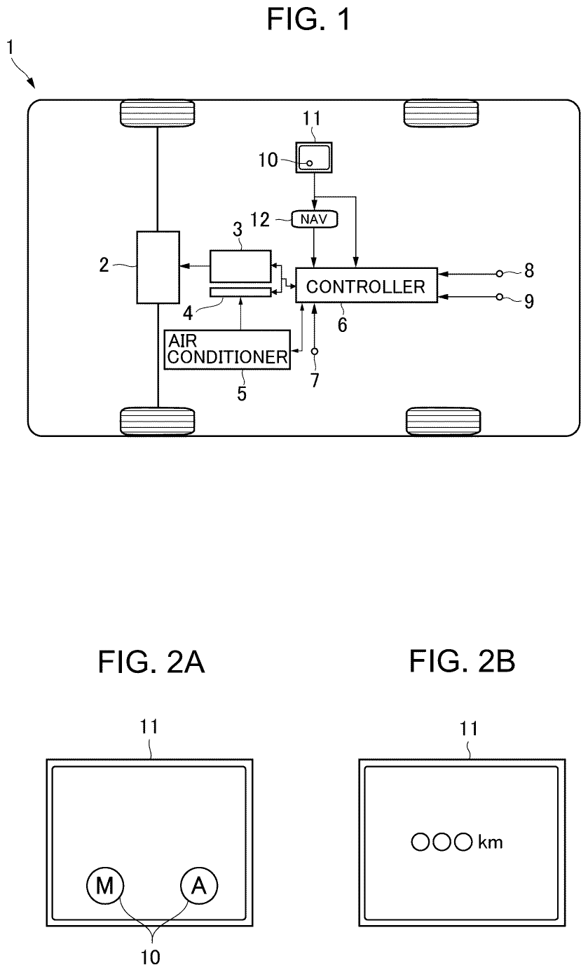

The driving range monitoring system according to the exemplary embodiment of the present disclosure is configured to monitor a driving range of an electric vehicle (hereinafter simply referred to as the vehicle) including a battery electric vehicle (BEV) and a plug-in hybrid vehicle (PHEV) propelled by an electric power. Referring now to FIG. 1, there is shown one example of a structure of a vehicle 1 to which the driving range monitoring system according to the exemplary embodiment of the present disclosure is applied. A prime mover 2 of the vehicle 1 includes an electric motor such as a motor/generator. An electric power is supplied to the prime mover 2 from an electric storage device 3, and an electric power generated by the prime mover 2 may be accumulated in the electric storage device 3. For example, a secondary battery such as a lithium-ion battery may be adopted as the electric storage device 3. Since charging and discharging properties of the electric storage device 3 change depending on a temperature of the electric storage device 3, the vehicle 1 is provided with a heater 4 for heating the electric storage device 3 to raise the temperature of the electric storage device 3 to a level at which the charging and discharging properties of the electric storage device 3 are optimized. To this end, for example, a heating device having a dedicated heat source may be adopted as the heater 4. Instead, a heating device adapted to heat the electric storage device 3 utilizing a heat generated by a heat source of an air-conditioning system 5 may also be adopted as the heater 4. In any of these cases, the electric storage device 3 is heated using an electric power accumulated in the electric storage device 3.

The heater 4 is controlled by a controller 6 to heat the electric storage device 3, that is, to raise the temperature of the electric storage device 3. The controller 6 comprises a central processing unit (i.e., a CPU), a memory element (including a ROM, a RAM, and a SRAM), and an interface, and performs a calculation based in incident data using data and programs stored therein. A calculation result is transmitted from the controller 6 in the form of a command signal. The vehicle 1 is activated by turning on a main switch 7 and inactivated by turning off the main switch 7. That is, the main switch 7 serves as an ignition switch or a ready switch, and on/off signals of the main switch 7 are transmitted to the controller 6. Here, it is to be noted that the controller 6 may be operated even when the main switch 7 is off.

In addition, in order to control the temperature of the electric storage device 3, detection signals are also transmitted to the controller 6 from a temperature sensor 8 that detects the temperature of the electric storage device 3 and an external temperature sensor 9 that detects an external temperature.

The controller 6 is configured to select a heating mode of the electric storage device 3 from a manual heating mode (hereinafter simply referred to as the manual mode) and an automatic heating mode (hereinafter simply referred to as the automatic mode). In the manual mode, the heating of the electric storage device 3 is started upon execution of a manual operation by a driver or user (i.e., an occupant) of the vehicle 1, and terminated upon satisfaction of a predetermined condition, e.g., when the temperature of the electric storage device 3 is raised to a target level. Whereas, in the automatic mode, the heating of the electric storage device 3 is started upon reception of a detection signal of a condition of the vehicle 1, e.g., a detection signal of a location of the vehicle 1, and also terminated upon satisfaction of a predetermined condition, e.g., when the temperature of the electric storage device is raised to a target level. In order to select the heating mode, a selection signal is transmitted to the controller 6 from a selector switch 10.

For example, a contact relay such as a push switch and a touch sensitive switch indicated in a touch panel of an indicator 11 in the form of an icon may be adopted as the selector switch 10. An example of the icons indicated in the indicator 11 is shown in FIG. 2A. In the example shown in FIG. 2A, the icon in which the letter “M” is enclosed by a circle serves as the selector switch 10 for selecting the manual mode, and the icon in which the letter “A” is enclosed by a circle serves as the selector switch 10 for selecting the automatic mode. Those switches 10 are turned on and off every time a user touches the icons thereof, and the icon of the selector switch 10 turned on by the user is activated. For example, in a case that the user touches the icon of the selector switch 10 for selecting the manual mode, the manual mode is selected and the icon thereof is activated. In this case, the icon of the selector switch 10 for selecting the automatic mode is inactivated. Then, when the user touches the inactivated icon of the selector switch 10 for selecting the automatic mode, the automatic mode is selected and the icon thereof is activated. Consequently, the icon of the selector switch 10 for selecting the manual mode which has been activated is inactivated.

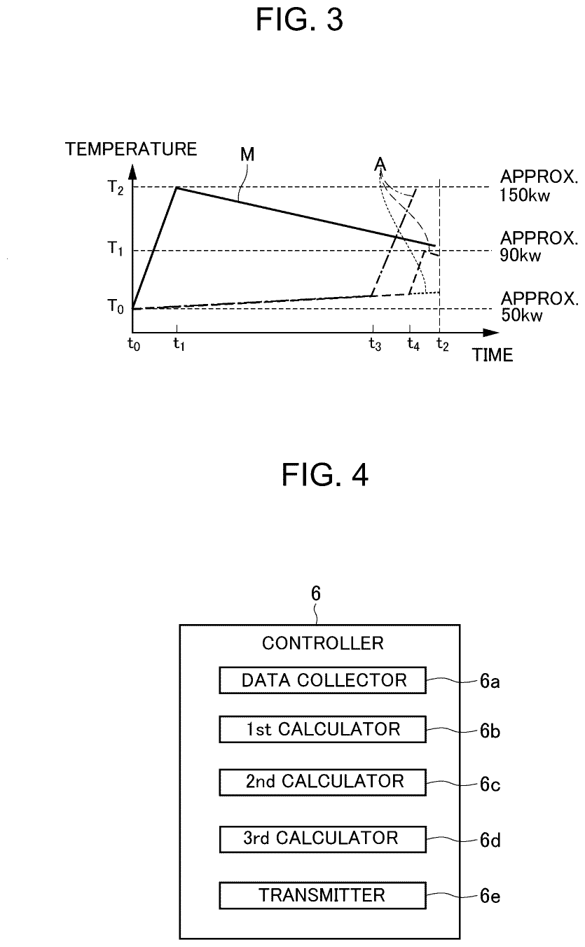

Here will be explained the manual mode and the automatic mode in more detail. The manual mode is selected to raise the temperature of the electric storage device 3 by activating the heater 4 for the preparation of charging the electric storage device 3 by an external charging facility (not shown). Specifically, the manual mode is selected by operating the selector switch 10 to select the manual mode during propulsion of the vehicle 1 or in the situation where the main switch 7 is on. Changes in the temperature of the electric storage device 3 in the manual mode and the automatic mode are indicated in FIG. 3. In FIG. 3, the vertical axis represents the temperature of the electric storage device 3, the horizontal axis represents time, the solid curve represented by the symbol “M” indicates a change in the temperature of the electric storage device 3 in the manual mode, and the dashed curves represented by the symbol “A” indicate changes in the temperature of the electric storage device 3 in the automatic mode. At point t0, the manual mode is selected by operating the selector switch 10. Consequently, the heater 4 is energized to heat the electric storage device 3 so that the temperature of the electric storage device 3 is raised gradually from point t0. In this situation, an increase rate of the temperature of the electric storage device 3 is governed by an amount of heat generated by the heater 4, a thermal resistance between the heater 4 and the electric storage device 3, a radiation amount from the electric storage device 3 according to an external temperature and so on.

An optimum temperature level of the electric storage device 3 at which the electric storage device 3 may be charged efficiently differs according to a charging capacity of the charging facility. For example, given that the charging capacity of the charging facility is approximately 50 Kw, the optimum temperature level of the electric storage device 3 is approximately T0° C. Given that the charging capacity of the charging facility is approximately 90 Kw, the optimum temperature level of the electric storage device 3 is approximately T1(>T0)° C. Given that the charging capacity of the charging facility is approximately 150 Kw, the optimum temperature level of the electric storage device 3 is approximately T2(>T1)° C. In the manual mode, if the electric storage device 3 is not going to be charged, or if the electric storage device 3 is going to be charged but a capacity of the charging facility is unknown, the temperature level corresponding to the maximum charging capacity of the charging facility (i.e., T2° C.) is employed as a target temperature level and the temperature of the electric storage device 3 is raised to T2° C. When the temperature of the electric storage device 3 is raised to T2° C. at point t1, the power supply to the heater 4 is stopped so that the temperature the electric storage device 3 is no longer raised. Then, the heat of the electric storage device 3 is dissipated naturally so that the temperature of the electric storage device 3 is gradually lowered.

Whereas, in the automatic mode, the temperature of the electric storage device 3 is raised automatically in accordance with conditions of the vehicle 1 including a distance from a current location of the vehicle 1 to the charging facility, and an estimated time to arrive at the charging facility. For example, a location of the charging facility may be found with reference to a map data. Otherwise, the location of the charging facility may be set as a destination in a navigation system 12. Thus, in the automatic mode, the temperature of the electric storage device 3 is raised based on data about the current position or location of the vehicle 1 and data about the location of the charging facility collected by the navigation system 12. Specifically, the navigation system 12 is configured to specify the locations of the vehicle 1 and the charging facility by detecting the locations of the vehicle 1 and the charging facility utilizing a GPS (i.e., global positioning system), and superimposing the positional information collected by the GPS on the map data. Therefore, the distance from the current location of the vehicle 1 to the charging facility, and the estimated time (or an estimated clock time) to arrive at the charging facility in accordance with a speed of the vehicle 1 may be obtained by the navigation system 12. In addition, charging capacities of the charging facilities may be stored in the navigation system 12 in advance.

A required time to raise the temperature of the electric storage device 3 to the target temperature level may be obtained based on a difference between the current temperature of the electric storage device 3 and the target temperature level. Accordingly, a timing to start the heating of the electric storage device 3, that is, a clock time or a distance to the charging facility to start the heating of the electric storage device 3 may be determined based on the required time and the current speed of the vehicle 1. For example, given that the charging capacity of the charging facility as the destination for which the vehicle 1 is headed is 150 Kw and that the automatic mode is selected, the heating of the electric storage device 3 is started from point t3 as indicated by the dashed-dotted curve represented by the symbol “A”. Whereas, given that the charging capacity of the charging facility as the destination for which the vehicle 1 is headed is 90 Kw and that the automatic mode is selected, the heating of the electric storage device 3 is started when the vehicle 1 comes closer to the charging facility, that is, from point t4 as indicated by the dashed curve also represented by the symbol “A”. In the automatic mode, the heating of the electric storage device 3 is also terminated when the temperature of the electric storage device 3 is raised to the target temperature level.

The controller 6 is configured to execute and terminate or cease the heating of the electric storage device 3 and to inhibit and permit a restart of the heating of the electric storage device 3, based on the incident data and the data stored therein. In addition, the controller 6 is further configured to calculate a driving range available with a current state of charge level of the electric storage device 3 and to indicate the calculated driving range on the indicator 11, also based on the incident data and the data stored therein. As shown in FIG. 4, the controller 6 comprises a data collector 6a, a first calculator 6b, a second calculator 6c, a third calculator 6d, and a transmitter 6e.

The data collector 6a is configured to collect data detected by the sensors, and data stored in the controller 6 in advance. For example, the data collector 6a collects data about: a heating demand arose by operating the selector switch 10; a state of charge (hereinafter abbreviated as SOC) level of the electric storage device 3; a temperature of the electric storage device 3; a target temperature of the electric storage device 3; heat capacities of the electric storage device 3 and the heater 4; a rate of power consumption to propel the vehicle 1 as a relation between an amount of the electric power consumed by the prime mover 2 and auxiliaries to propel the vehicle 1 and a travel distance; and a rate of power consumption to heat the electric storage device 3 to the target temperature level as a relation between an amount of the electric power consumed to raise the temperature of the electric storage device 3 to the target temperature level and a travel distance. For example, those data may be collected from a computer controlling the prime mover 2 and a computer controlling the air-conditioning system 5. In addition, those data may also be collected by reading data stored in memory elements. Specifically, the rate of power consumption to propel the vehicle 1 and the rate of power consumption to heat the electric storage device 3 may be calculated based on data about a power consumption, a travel distance, and driving hours collected during propulsion of the vehicle 1 in the past. That is, the rate of power consumption to propel the vehicle 1 and the rate of power consumption to heat the electric storage device 3 may be calculated based on data collected from an operating record of the vehicle 1. Instead, the rate of power consumption to propel the vehicle 1 and the rate of power consumption to heat the electric storage device 3 may also be set in a design phase based on a result of an experimentation or a simulation.

The first calculator 6b is configured to calculate a first driving range L1 as an available distance to travel with an available electric power in a situation where the heating demand of the electric storage device 3 arises during propulsion of the vehicle 1. Specifically, the available electric power is calculated by subtracting a required amount of the electric power to raise the temperature of the electric storage device 3 to the target temperature level (that is, to heat the electric storage device 3) from a current amount of the electric power remaining in the electric storage device 3. To this end, the required amount of the electric power to heat the electric storage device 3 may be calculated based on a difference between a current temperature of the electric storage device 3 and the target temperature level, and heat capacities of the electric storage device 3, the heater 4, and portions belonging to those elements. Instead, the required amount of the electric power to heat the electric storage device 3 may also be determined with reference to a map configured to determine the required amount of the electric power with respect to the difference between the temperature of the electric storage device 3 and the target temperature level.

Specifically, the first driving range L1 may be calculated based on the available electric power and the rate of power consumption to propel the vehicle 1. To this end, the rate of power consumption to propel the vehicle 1 may be obtained from the data collected during propulsion of the vehicle 1. For example, the rate of power consumption to propel the vehicle 1 may be calculated based on: an amount of the electric power Wo consumed by the prime mover 2 and the auxiliaries including the air-conditioning system 5 (i.e., a power consumption) during propulsion before a point at which the heating demand arose; and a travel distance Lo of the vehicle 1 in which the electric power Wo was measured. That is, the rate of power consumption to propel the vehicle 1 may be calculated by dividing the measured power consumption Wo by the travel distance Lo. For example, the first driving range L1 may be calculated using the following formula:

$$L 1 = ( SOC - Wh ) \cdot 1 / α r : ( α r = Wo / Lo )$$

where “Wh” is the required amount of the electric power to heat the electric storage device 3, and “αr” is the rate of power consumption to propel the vehicle 1 (i.e., a first power consumption rate).

The second calculator 6c is configured to calculate a second driving range L2 in the situation where the heating demand of the electric storage device 3 arises during propulsion of the vehicle 1. Specifically, the second driving range L2 is an available distance to travel with a current SOC level of the electric storage device 3 given that the prime mover 2 is driven by the electric power remaining in the electric storage device 3, and that the electric storage device 3 is also heated by the electric power remaining in the electric storage device 3. Specifically, the second driving range L2 may be calculated based on: a total rate of the rate of power consumption to propel the vehicle 1 by driving the prime mover 2 by the electric power, and the rate of power consumption to heat the electric storage device 3 by the electric power during propulsion; and the SOC level of the electric storage device 3. In order to calculate the second driving range L2, the rate of power consumption to heat the electric storage device 3 is calculated by the following procedures. First of all, the required amount of the electric power to heat the electric storage device 3 is calculated based on the above-mentioned temperature difference of the electric storage device 3 and the heat capacities. In addition, a rate of temperature increase in the electric storage device 3 is calculated. Specifically, the rate of temperature increase in the electric storage device 3 is governed by: an amount of heat generation of the electric storage device 3; and a heat transfer coefficient between the heater 4 and the electric storage device 3. Therefore, the rate of temperature increase in the electric storage device 3 may be determined in advance based on a result of experimentation or simulation using actual equipment. Consequently, a required time to raise the temperature of the electric storage device 3 to the target temperature level is obtained based on the required amount of the electric power to heat the electric storage device 3 and the rate of temperature increase in the electric storage device 3, and a travel distance of the vehicle 1 during the calculated required time is also determined. Then, the rate of power consumption to heat the electric storage device 3 is obtained based on the calculated travel distance of the vehicle 1 and the required amount of the electric power to heat the electric storage device 3. For example, the rate of power consumption to heat the electric storage device 3 may be calculated every time the heating demand of the electric storage device 3 arises during propulsion of the vehicle 1. Instead, the rate of power consumption to heat the electric storage device 3 may also be estimated in advance based on a result of experimentation or simulation. That is, the second driving range L2 is calculated based on a consumable electric power, and the rate of power consumption calculated taking account of the heating operation of the electric storage device 3. In other words, the second driving range L2 is calculated based on the consumable electric power, and the aforementioned total rate of the rate of power consumption to propel the vehicle 1 and the rate of power consumption to heat the electric storage device 3. For example, the second driving range L2 may be calculated using the following formula:

$$L 2 = SOC \cdot 1 / α h : ( α h = ( Wo + Wh ) / Lo )$$

where “Wh” is the required amount of the electric power consumed to heat the electric storage device 3 during propulsion, and “αh” is the total rate of the power consumption (i.e., a second power consumption rate).

The third calculator 6d is configured to calculate a third driving range L3 in the situation where the heating of the electric storage device 3 is not demanded during propulsion of the vehicle 1. In the situation where the heating of the electric storage device 3 is not demanded, as in the normal operation, the electric power accumulated in the electric storage device 3 is consumed by the prime mover 2 and the auxiliaries including the air-conditioning system 5. Therefore, the third driving range L3 is calculated based on the SOC level of the electric storage device 3 and the rate of power consumption αr to propel the vehicle 1 (i.e., the first power consumption rate), as expressed by the following expression:

$$L 3 = SOC \cdot 1 / α r : ( α r = ( Wo / Lo ) ) .$$

The transmitter 6e is configured to indicate any of the driving ranges L1, L2, and L3 on the indicator 11. Specifically, in the situation where the heating of the electric storage device 3 is demanded, the transmitter 6e transmits a command to the indicator 11 to indicate the longer one of the first driving range L1 and the second driving range L2 on the indicator 11. Whereas, in the situation where the heating of the electric storage device 3 is not demanded, the transmitter 6e transmits a command to the indicator 11 to indicate the third driving range L3 on the indicator 11. An example of the driving range indicated on the indicator 11 is shown in FIG. 2B.

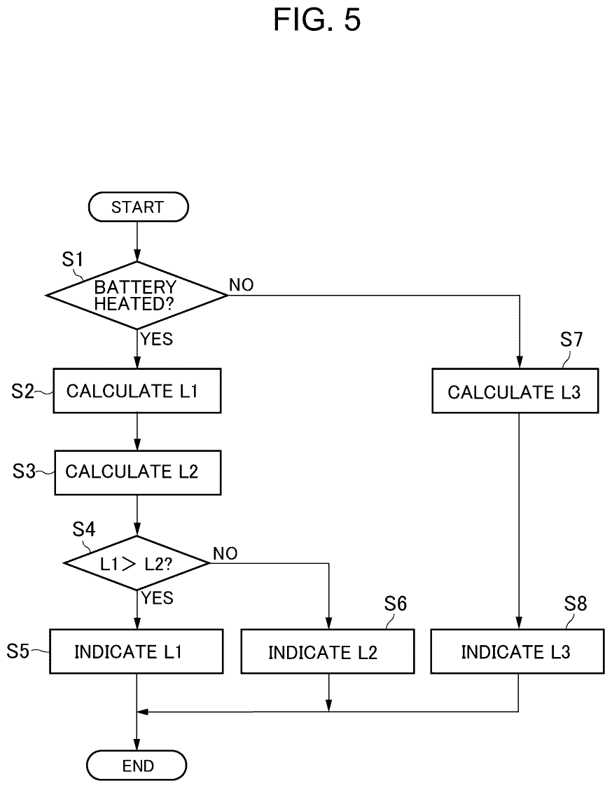

Next, an example of the routine executed by the controller 6 will be explained with reference to FIG. 5. The routine shown in FIG. 5 is executed repeatedly in the situation where the main switch 7 is on to propel the vehicle 1. At step S1, it is determined whether the electric storage device 3 is being heated by the heat generated by the heater 4 in any of the manual mode and the automatic mode. Accordingly, such determination at step S1 may also be made by determining whether the heater 4 is generating heat.

If the electric storage device 3 is heated so that the answer of step S1 is YES, the routine progresses to calculate the first driving range L1 and the second driving range L2. Here, it is to be noted that the order to calculate the first driving range L1 and the second driving range L2 may be executed in random order. According to the example shown in FIG. 5, the first driving range L1 is calculated at step S2, and the second driving range L2 is calculated at step S3. As explained above, specifically, the first driving range L1 is calculated based on: the available electric power calculated by subtracting the required amount Wh of the electric power to raise the temperature of the electric storage device 3 from the current amount of the electric power remaining in the electric storage device 3; and the rate of power consumption αr to propel the vehicle 1 (i.e., the first power consumption rate) calculated during a previous trip. On the other hand, the second driving range L2 is calculated based on: the total rate αh of the power consumption (i.e., the second power consumption rate) calculated taking account of the rate of power consumption to heat the electric storage device 3 during propulsion of the vehicle 1, and the current SOC level of the electric storage device 3. As described above, the first driving range L1 and the second driving range L2 may be expressed by the above-mentioned expressions.

Then, it is determined at step S4 which of the first driving range L1 and the second driving range L2 is longer. According to the example shown in FIG. 5, specifically, it is determined at step S4 whether the first driving range L1 is longer than the second driving range L2, and longer driving range is indicated on the indicator 11. For example, if the first driving range L1 is longer than the second driving range L2 so that the answer of step S4 is YES, the routine progresses to step S5 to indicate the first driving range L1 on the indicator 11, and thereafter returns. By contrast, if the second driving range L2 is longer than the first driving range L1 so that the answer of step S4 is NO, the routine progresses to step S6 to indicate the second driving range L2 on the indicator 11, and thereafter returns.

Whereas, if the heating of the electric storage device 3 is not demanded so that the answer of step S1 is NO, the routine progresses to step S7 to calculate the third driving range L3 by the above-explained procedure using the above-mentioned expression. Then, the routine progresses to step S8 to indicate the third driving range L3 on the indicator 11, and thereafter returns.

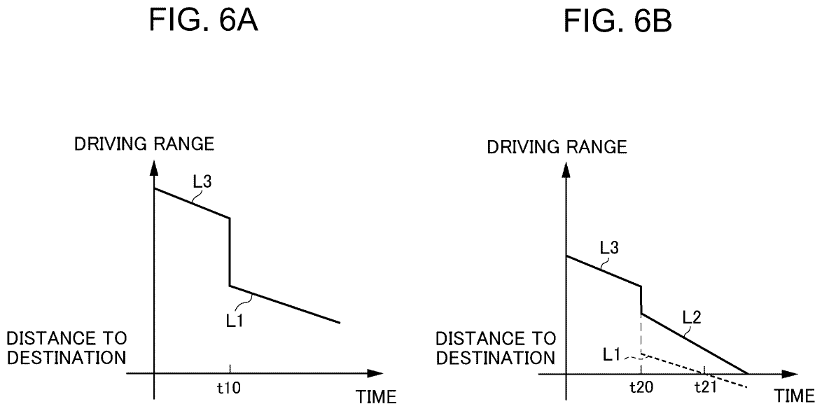

Here will be explained a situation in which the first driving range L1 and the second driving range L2 are different with reference to FIGS. 6A and 6B showing a temporal change in the driving range after the commencement of the heating of the electric storage device 3. Specifically, FIG. 6A shows an example of a case in which the SOC level of the electric storage device 3 is high, and FIG. 6B shows an example of a case in which the SOC level of the electric storage device 3 is low. The SOC level of the electric storage device 3 falls gradually by consuming the electric power by the prime mover 2 and the auxiliaries including the air-conditioning system 5, and as a result, the driving range is reduced gradually at a rate corresponding to the above-mentioned rate of power consumption αr to propel the vehicle 1 (i.e., the first power consumption rate). In this situation, the third driving range L3 is calculated and indicated on the indicator 11.

In the example shown in FIG. 6A the heating of the electric storage device 3 is commenced at point t10. In this example, the SOC level of the electric storage device 3 is sufficiently high at the commencement of the heating of the electric storage device 3, and hence the driving range is reduced from the third driving range L3 to the first driving range L1 as indicated by the solid curve. Specifically, the driving range is reduced in an amount corresponding to the required amount Wh of the electric power to raise the temperature of the electric storage device 3. Then, the first driving range L1 is reduced gradually from point t10 at a rate corresponding to the rate of power consumption αr to propel the vehicle 1 (i.e., the first power consumption rate). In this situation, if the available electric power calculated by subtracting the required amount Wh of the electric power to raise the temperature of the electric storage device 3 from the amount of the electric power remaining in the electric storage device 3 at point t10 is greater than a predetermined threshold value, the driving range of the vehicle 1 is sufficiently long. In this case, the vehicle 1 is allowed to travel through the first driving range L1, therefore, the first driving range L1 is indicated on the indicator 11.

Thus, in the example shown in FIG. 6A, the SOC level of the electric storage device 3 is sufficiently high so that the vehicle 1 is allowed to be propelled continuously while heating the electric storage device 3. In this case, therefore, the driving rage may be indicated accurately on the indicator 11 based on the actual condition of the vehicle 1. In addition, the driver is allowed to feel a sense of security and to confirm a current condition of the vehicle 1 accurately by the first driving range L1 indicated on the indicator 11 which is relatively longer.

In the example shown in FIG. 6B, the SOC level of the electric storage device 3 is low, and the heating of the electric storage device 3 is commenced at point t20. Consequently, the driving range is reduced from the third driving range L3 and the first driving range L1 and the second driving range L2 are calculated. In this situation, as indicated by the dashed curve in FIG. 6B, the first driving range L1 is significantly shortened from the third driving range L3 by calculating the first driving range L1 based on the available electric power calculated by subtracting the required amount Wh of the electric power to raise the temperature of the electric storage device 3 from the current amount of the electric power remaining in the electric storage device 3. Whereas, since the second driving range L2 is calculated based on the rate of power consumption taking account of the heating operation of the electric storage device 3, the second driving range L2 is slightly shortened from the third driving range L3 by the inevitable power consumption in the initial phase of the heating operation. Then, the first driving range L1 and the second driving range L2 decrease individually at the above-mentioned predetermined rates.

Specifically, from point t20, the first driving range L1 decreases gradually from the driving range corresponding to the available electric power calculated by subtracting the required amount Wh of the electric power to raise the temperature of the electric storage device 3 from the current amount of the electric power remaining in the electric storage device 3. Eventually, the first driving range L1 decreases shorter than the distance to the destination at point t21. In this situation, therefore, the vehicle 1 may not reach the destination and the heating of the electric storage device 3 have to be terminated according to calculation. In this situation, however, the electric power for heating the electric storage device 3 still remains at least partially, and the vehicle 1 is still allowed to be propelled by the remaining electric power for heating the electric storage device 3. On the other hand, as indicated by the solid curve in FIG. 6B, the second driving range L2 also decreases gradually from point t20. In this situation, the second driving range L2 decreases at a higher rate than the reduction rate of the first driving range L1, but the second driving range L2 decreases from the driving range corresponding to the current SOC level of the electric storage device 3. Therefore, the calculated value of the second driving range L2 is always longer than the first driving range L1 from point t20, and the second driving range L2 is indicated on the indicator 11 from point t20. For example, such control may be executed in a case that the available electric power calculated by subtracting the required amount Wh of the electric power to raise the temperature of the electric storage device 3 from the amount of the electric power remaining in the electric storage device 3 at point t20 is less than a predetermined value.

Thus, in the case of heating the electric storage device 3 in the situation where the SOC level of the electric storage device 3 is low, the driving range as the available distance to travel with the total amount of the electric power accumulated in the electric storage device 3 is indicated on the indicator 11. Therefore, the driving range of the vehicle 1 may be monitored accurately in accordance with the actual condition of the vehicle 1. For this reason, the driver is allowed to accurately figure out the current available driving range and the current available performance of the vehicle 1.

Although the above exemplary embodiment of the present disclosure has been described, it will be understood by those skilled in the art that the driving range monitoring system according to the present disclosure should not be limited to the described exemplary embodiment, and various changes and modifications can be made within the scope of the present disclosure. For example, the above-mentioned formulas for calculating the first driving range L1 and the second driving range L2 may be modified according to need as long as the first driving range L1 is calculated based on the above-mentioned available electric power and the second driving range L2 is calculated based on the SOC level of the electric storage device 3. In addition, the rate of power consumption to propel the vehicle 1 and the rate of power consumption to heat the electric storage device 3 may be determined taking account of other parameters in accordance with the characteristics and the structure of the vehicle 1. Further, the driving range may also be indicated on the indicator 11 in the form of a graph, a figure, or a colored figure which can be recognized visually by the driver.

What is claimed is:

1. A driving range monitoring system that monitors a driving range of an electric vehicle having an electric storage device that accumulates an electric power for propelling the electric vehicle, and a heater that heats the electric storage device using the electric power accumulated in the electric storage device, comprising:
an indicator that indicates a driving range available with a current state of charge level of the electric storage device; and
a controller that calculates the driving range indicated on the indicator,
wherein the controller comprises:
a first calculator that is configured to calculate a first driving range available with an available electric power calculated by subtracting a required amount of the electric power to raise a temperature of the electric storage device to a target temperature level from an amount of the electric power remaining in the electric storage device, in a situation where a demand to heat the electric storage device arises during propulsion of the electric vehicle;
a second calculator that is configured to calculate a second driving range available with the electric power remaining in the electric storage device given that a prime mover is driven by the electric power remaining in the electric storage device, and that the electric storage device is heated by the electric power remaining in the electric storage device, in the situation where the demand to heat the electric storage device arises during propulsion of the electric vehicle; and
a transmitter that is configured to indicate the longer one of the first driving range and the second driving range on the indicator.

2. The driving range monitoring system as claimed in claim 1,
wherein the first calculator is further configured to calculate the first driving range based on: a rate of power consumption to propel the electric vehicle obtained from data collected during propulsion of the electric vehicle; and the available electric power, and
the second calculator is further configured to calculate the second driving range based on: a total rate of the rate of power consumption to propel the electric vehicle obtained from data collected during propulsion of the electric vehicle, and a rate of power consumption to raise the temperature of the electric storage device to the target temperature level; and the electric power remaining in the electric storage device.

3. The driving range monitoring system as claimed in claim 1,
wherein the controller further comprises a third calculator that is configured to calculate a third driving range based on: the electric power remaining in the electric storage device; and the rate of power consumption to propel the electric vehicle obtained from data collected during propulsion of the electric vehicle, in a situation where a heating of the electric storage device is not demanded during propulsion of the electric vehicle, and
the transmitter is further configured to indicate the third driving range on the indicator in the situation where the heating of the electric storage device is not demanded during propulsion of the electric vehicle.

4. The driving range monitoring system as claimed in claim 2,
wherein the controller further comprises a third calculate that is configured to calculate a third driving range based on: the electric power remaining in the electric storage device; and the rate of power consumption to propel the electric vehicle obtained from data collected during propulsion of the electric vehicle, in a situation where a heating of the electric storage device is not demanded during propulsion of the electric vehicle, and
the transmitter is further configured to indicate the third driving range on the indicator in the situation where the heating of the electric storage device is not demanded during propulsion of the electric vehicle.

5. The driving range monitoring system as claimed in claim 1, wherein the electric storage device includes a secondary battery.

6. The driving range monitoring system as claimed in claim 2, wherein the electric storage device includes a secondary battery.
